(19) United States
(12) Patent Application Publication
(10) Pub. No.: US 2010/0063666 A1
(43) Pub. Date: Mar. 11, 2010

(54) METHOD AND CONTROL DEVICE FOR IDENTIFYING A TRAILERING MODE IN A TOWING VEHICLE

(76) Inventors: Andreas Schumann, Tamm (DE); Lars Berding, Seoul (KR); Rolf-Hermann Mergenthaler, Leonberg (DE); Daniel Fellke, Stuttgart (DE); Gero Nenninger, Tamm (DE); Michael Brander, Neuenstadt (DE)

Correspondence Address: KENYON & KENYON LLP, ONE BROADWAY, NEW YORK, NY, 10004, US

(21) Appl. No.: 12/302,461

(22) PCT Filed: May 11, 2007
(86) PCT No.: PCT/EP2007/054565

§ 371 Date: Aug. 28, 2009

(30) Foreign Application Priority Data
Jun. 27, 2006 (DE) 10 2006 029 365.7
Nov. 21, 2006 (DE) 10 2006 054 703.9

(51) Int. Cl. B60T 8/1755

(52) U.S. Cl. 701/29

(57) ABSTRACT

In a method for identifying a trailering mode in the context of a towing vehicle, in particular as part of a vehicle dynamics control system having a trailer roll logic function for stabilizing the combination of towing vehicle and trailer, and a control device for carrying out the method, identification of the trailering mode is accomplished by a comparison of an actual signal characterizing the vehicle state with a corresponding target signal.

### FIELD OF THE INVENTION

The present invention relates to a method for identifying whether or not a vehicle is in a trailering mode, and to a control device for carrying out such a method.

### BACKGROUND INFORMATION

DE 199 64 048 describes a vehicle dynamics control system having a trailer roll logic function for stabilizing a road vehicle. The towing vehicle is monitored for roll motions; upon identification of a roll motion, the vehicle is automatically decelerated and/or a yaw moment that counteracts the roll motion is impressed.

A conventional trailer roll logic function is usually activated only when an identification is made as to whether or not a trailer is hitched to the towing vehicle. A conventional arrangement contains apparatuses for identifying a trailer, in which apparatuses the signal for identifying a trailering mode is taken from an apparatus that creates a direct connection from the trailer to the towing vehicle. The signal is usually derived by checking the occupancy of a brake-light plug connector and consequently inferring the presence of a trailer.

DE 197 44 066, in particular, describes an apparatus for identifying a trailering mode for a motor vehicle, in which, as a function of the pressure applied to the trailer, a variable characterizing the pressure buildup is ascertained, and a determination is made on the basis of said variable as to whether or not a trailer is attached. The apparatus described in DE 197 44 066 presupposes a system having a component for sensing the pressure controlled to the trailer, generally at least a braked trailer. These presuppositions are not always met, with the result that an identification cannot be made for such cases.

In some cases, however, the aforesaid procedures can result in incorrect verifications of the variable representing the presence of the trailer, and thus to incorrect interventions by the vehicle dynamics control system or to suboptimal behavior in terms of vehicle-dynamics, drive-system, and brake-slip regulation and trailer stabilization logic functions. The following cases, for example, can result in incorrect verifications of the variable representing the presence of the trailer:

The apparatus indicating the presence of the trailer is not present or is not being used in the towing vehicle. In countries outside Europe, for example, there is in some cases no obligation to use a brake light plug connector in trailering mode.

The apparatus indicating the presence of the trailer is occupied not by a trailer, but by a different apparatus, for example a bicycle carrier. The vehicle dynamics control system consequently receives the information that the vehicle is being operated with a trailer, even though a trailer is not hitched to the towing vehicle.

### SUMMARY

Example embodiments of the present invention provide a method for identifying a trailering mode in the context of a towing vehicle, in particular as part of a vehicle dynamics control method, with which method a reliable identification can be made as to whether or not the towing vehicle is in trailering mode. Example embodiments provide a corresponding control device for carrying out the method.

Example embodiments of the present invention infer, based on evaluation of a variable available in any case to a vehicle dynamics control system, whether or not the towing vehicle is in a trailering mode. Based on the result of the evaluation, a trailer logic function and/or a vehicle dynamics control system can be modified, in particular activated, deactivated, sensitized, and/or desensitized. If the existence of a trailering mode is identified, the trailer roll logic function can, for example, be adapted by setting it to be more sensitive. In addition, intervention thresholds can be lowered. Correspondingly, the trailer roll logic function is attenuated, or intervention thresholds are raised and incorrect stimuli are prevented, for the case in which the trailer identification system does not identify a trailer hitched to the towing vehicle. The method can, however, also be used independently of a vehicle dynamics control system and can serve, for example, to output a corresponding signal, in particular to activate a signal lamp in the vehicle cockpit, upon identification of a trailering mode.

Provision is made that the method for trailer identification is based on a comparison of an actual signal characterizing the vehicle state and a corresponding target signal.

According to an example embodiment, provision is made that the trailer identification is based on a comparison of an actual longitudinal vehicle acceleration signal with a target longitudinal vehicle acceleration signal. The target longitudinal vehicle acceleration is the longitudinal vehicle acceleration, ascertained from a reference model, to be expected in particular on the basis of a driver input. Exclusively a measured longitudinal vehicle acceleration signal, or exclusively a longitudinal vehicle acceleration signal calculated on the basis of state variables, or both longitudinal vehicle acceleration signals, can enter into the comparison. The measured actual longitudinal vehicle acceleration signal is measured using at least one acceleration sensor, whereas the calculated or estimated longitudinal vehicle acceleration signal is ascertained, for example, by derivation over time of at least one vehicle wheel speed signal. Both positive longitudinal vehicle acceleration signals and negative longitudinal vehicle acceleration signals caused by braking maneuvers can be taken into account in the comparison.

The target longitudinal vehicle acceleration signal is ascertained on the basis of a reference model having at least one input variable. A suitable input variable for the reference model for ascertaining the desired positive or negative target acceleration is, in particular, the gas pedal position or gas pedal travel and/or the gas pedal acceleration, as well as the braking pressure. Additionally or alternatively, the engine speed and/or current transmission ratio can be taken into account, for example, as input variables.

In an example embodiment, provision is made that a trailering mode is inferred on the basis of the assessment of a comparison value. The comparison value preferably corresponds to the difference between the target longitudinal vehicle acceleration and actual longitudinal vehicle acceleration. If applicable, further variables and/or correction factors can additionally enter into the determination of the comparison value. Additionally or alternatively, filtering methods, in particular Kalman filtering, can be used in calculating the comparison value.

According to an example embodiment, provision is made that the difference between the target longitudinal vehicle acceleration and actual longitudinal vehicle acceleration results by subtracting the actual longitudinal vehicle acceleration measured by an acceleration sensor from the target longitudinal vehicle acceleration from the reference model. The signs may be transposed depending on how the difference formation is converted into an algorithm. Alternatively thereto, it is possible, for forming the difference, to subtract the actual longitudinal vehicle acceleration, calculated in consideration of at least one vehicle wheel rotation speed, one vehicle wheel speed, and/or one vehicle wheel acceleration, from the target longitudinal vehicle acceleration. To prevent a trailer from failing to be identified because the vehicle is driving up- or downhill and the road slope is acting against the driver input—in which context it is even possible for acceleration or deceleration effects, brought about, for example, by the mass of a trailer, to be completely compensated for by a road slope of corresponding magnitude—provision is made in an example embodiment that the comparison value, in particular the difference between the target longitudinal vehicle acceleration and actual longitudinal vehicle acceleration, is purged of the acceleration component caused by the road slope. Provision is made for this purpose that the measured actual longitudinal vehicle acceleration is subtracted from, and the calculated longitudinal vehicle acceleration is added to, the comparison value, in particular from/to the difference. In contrast to the measured actual longitudinal vehicle acceleration, the calculated actual longitudinal vehicle acceleration does not contain the acceleration component caused by the road slope, with the result that the acceleration component caused by the road slope is deducted from the comparison value or from the difference. Here as well, it must be considered that the signs are of course transposable in the context of implementation in an algorithm.

If the comparison value exceeds a predefined first threshold value in a polling cycle, this is classified as trailering mode. For example, a trailering mode can be identified immediately, or the count status of a counter is modified, preferably increased.

In an example embodiment, provision is made that a classification of non-trailering mode is made when the comparison value falls below a second threshold value. Either non-trailering mode can be identified immediately, or firstly the count status of a counter can be modified, preferably lowered.

Provision is made that the first and the second threshold value are of different magnitudes. The first threshold value is preferably greater than the second threshold value. A hysteresis effect is thereby achieved. If the comparison value is lower than the first threshold value but still greater than the second threshold value, the count status is not modified. If the comparison value is greater than a first threshold value, this is classified as trailering mode.

A trailering mode is identified when a predefined count status of the counter is reached.

Preferably, the upper and/or the lower, i.e. the maximum or the minimum, count status is limited. As a result, once trailer identification has occurred, only a limited number of query steps in which the comparison value falls below the second threshold value is necessary in order to once again allow identification of a non-trailering mode.

Because elevated vehicle resistance values cannot be caused by off-road operation in the speed range of interest for trailer identification, since travel through off-road terrain at more than 60 km/h is improbable, a correspondingly large deviation between the actual longitudinal vehicle acceleration and target longitudinal vehicle acceleration must have a different cause, namely the presence of a trailer. Provision is therefore made, in an example embodiment, that evaluation of the actual longitudinal vehicle acceleration signal and of the target longitudinal vehicle acceleration signal is activated only once a minimum speed is exceeded.

According to an example embodiment, provision is made that trailer identification is activated only for a sufficiently large value of the driver input variable, for example of the gas pedal travel or the change in brake inlet pressure.

Because of disruptions of the actual signal and/or target signal after braking actions, provision is made in an example embodiment that a minimum time span after a braking action must be observed before an evaluation of the actual signal and target signal for trailer identification takes place.

Further advantages and aspects of example embodiments of the present invention are described in more detail below with reference to the Figures.

### BRIEF DESCRIPTION OF THE DRAWINGS

FIG. 1 schematically depicts a vehicle dynamics control system; and

FIGS. 2a and 2b illustrate a schematic flow chart of a vehicle dynamics control method.

### DETAILED DESCRIPTION

In the Figures, identical components and components having the same function are labeled with the same reference characters.

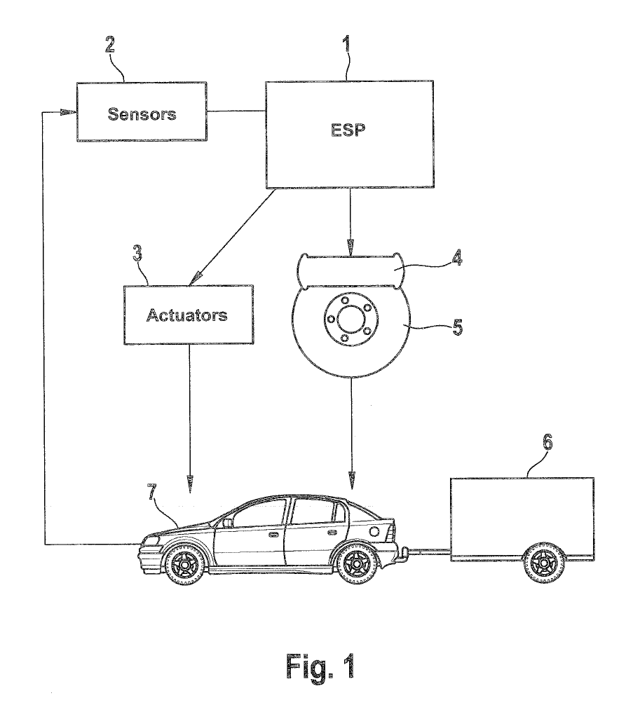

FIG. 1 schematically depicts the system architecture of a complex regulating system that encompasses a vehicle dynamics control system. The vehicle dynamics control system encompasses a control device 1 in which a control algorithm, in the present case an electronic stability program (ESP) and a trailer roll logic function are stored. The vehicle dynamics control system further encompasses a sensor suite 2 for determining the actual behavior, i.e. at least one actual signal, as well as multiple adjusting members 3, 4, 5 such as, for example, an engine control device, a steering positioner, etc., and a wheel brake 5, for influencing the vehicle behavior. Upon exceedance of a predefined intervention threshold, i.e. a predefined system deviation, brake 5, for example, is actuated in order to adapt the yaw behavior of a vehicle 7 to a target value and thus stabilize the vehicle. In trailering mode, i.e. when a trailer 6 is attached, it is possible to perform further interventions in order to stabilize vehicle states that occur especially in towing mode, for example trailer rolling.

Implemented in control device 1 is a reference model by which a target signal can be ascertained on the basis of at least one input variable, for example the gas pedal position and/or brake input pressure. According to example embodiments of the present invention, control device 1 compares the actual signal with the target signal in terms of certain properties, and thus identifies a trailering mode or a non-trailering mode depending on whether certain correlations are satisfied.

Example embodiments of the present invention will be explained below with reference to a comparison between an actual longitudinal vehicle acceleration signal and a target longitudinal vehicle acceleration signal. The present invention is not, however, limited to such a comparison.

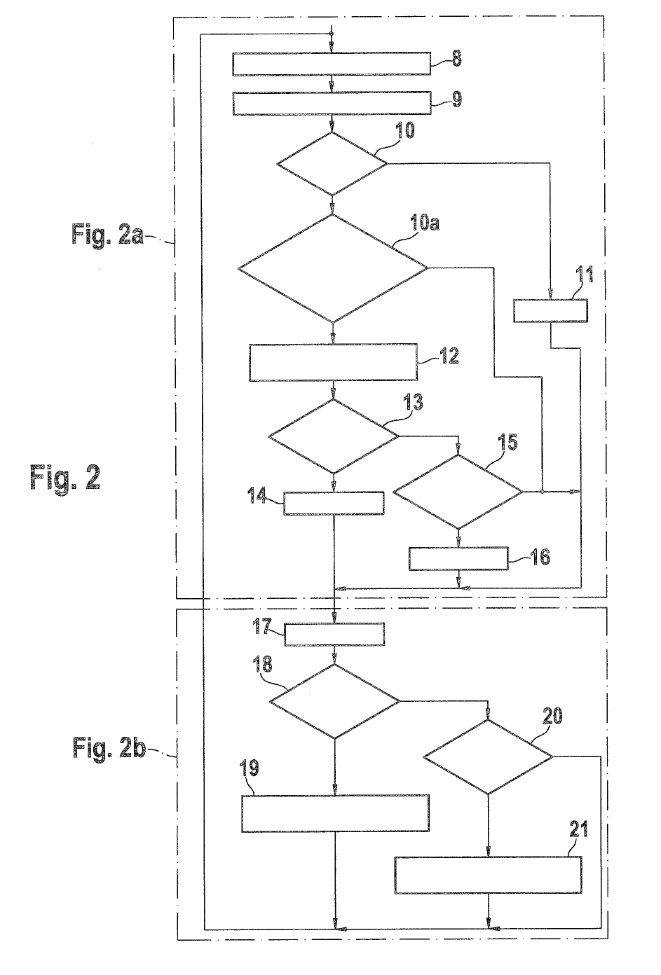

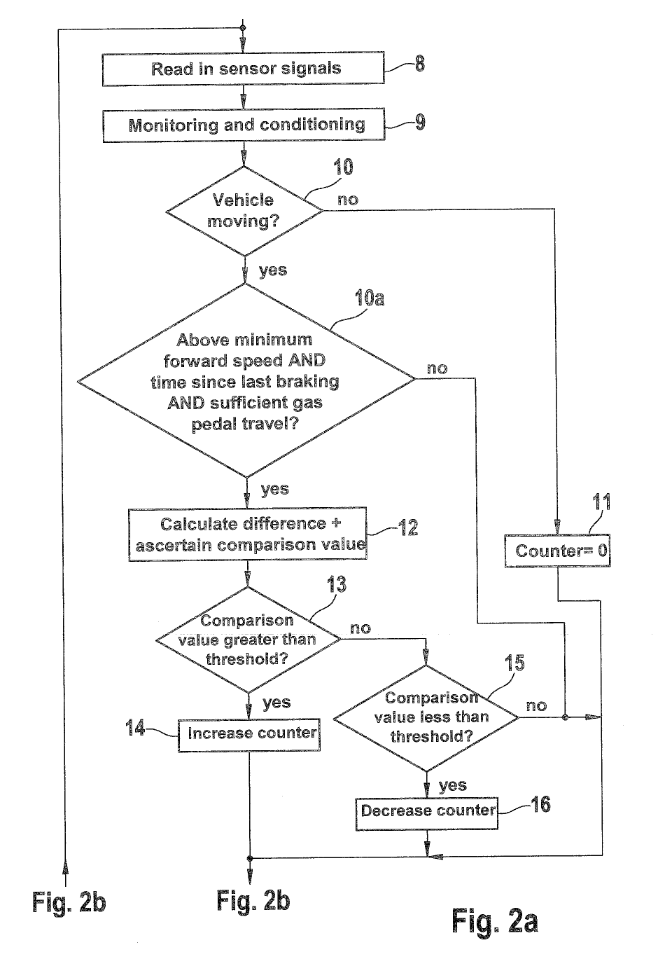

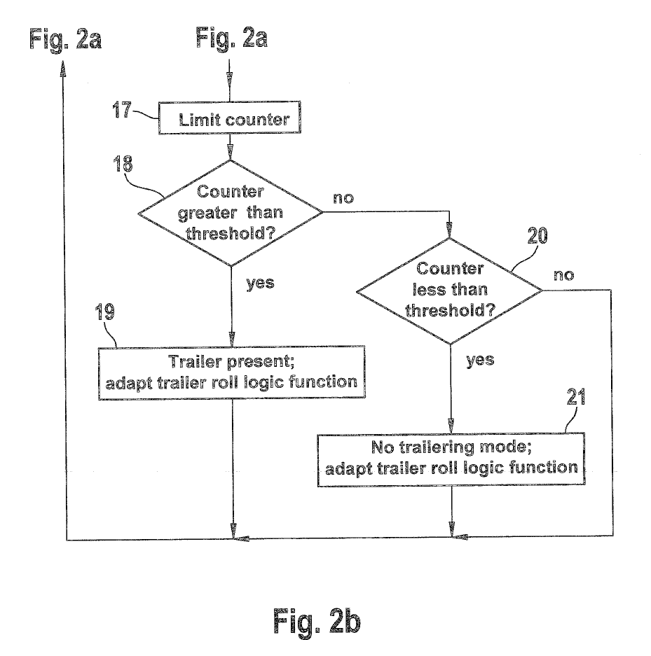

FIG. 2 shows an example embodiment of the trailer identification system, which is integrated into a vehicle dynamics control system, in particular an ESP. The necessary calculations and comparisons are carried out by control device 1 in FIG. 1.

In a first method step 8, firstly the sensor signals of sensor suite 2 according to FIG. 1 are read in, and in a second step 9 they are monitored and conditioned, in particular plausibilized. A subsequent step 10 checks, for example by monitoring the vehicle wheel speeds, whether or not vehicle 7 is moving. If it is not moving, in step 11 the counter (to be further explained later) is reset.

If vehicle movement is identified in step 10, a check is first made as to whether the vehicle is moving at a minimum speed, so that any deviations of the target longitudinal vehicle acceleration from the actual longitudinal vehicle acceleration are prevented from being attributed to off-road operation. A check is also made as to whether a minimum time since the last braking action has been observed, in order to avoid interference with the read-in sensor signals. A check is additionally made as to whether the input signal is sufficiently large for a reference model for ascertaining the target longitudinal vehicle acceleration. Only if all the queries are answered positively is a difference calculated, in a step 12, between a target longitudinal vehicle acceleration determined in a reference model and an actual longitudinal vehicle acceleration calculated by derivation over time of the vehicle wheel speed. A calculation step of this kind is already implemented in a large number of vehicle dynamics control systems. The difference, or in other words a raw value for the vehicle resistance, is employed to determine a comparison value. The comparison value or vehicle resistance value is calculated by subtracting from the aforesaid difference an acceleration component that is attributable to the road slope. The difference thus has this acceleration component purged from it. Compensation or intensification phenomena between an acceleration or deceleration caused by the additional trailer mass and an acceleration or deceleration caused by the road slope, i.e. the acceleration of gravity, are thus excluded. A step 13 subsequent thereto checks whether the comparison value ascertained in step 12 is greater than a first threshold value. If so, the count status of a counter is increased in a following step 14. If the comparison value is less than a first threshold value, a method step 15 checks whether the comparison value is less than a second threshold value, the second threshold value being lower than the first threshold value. Only if this is the case is the count status of the counter decreased in step 16. If the comparison value is less than the first value, but greater than the second threshold value, no change in the counter occurs (hysteresis).

In a method step 17, the maximum and minimum count status is limited. In a method step 18 that follows, a check is made as to whether the counter exceeds a first count status. If so, a step 19 then recognizes that the vehicle is in trailering mode. The trailer roll logic function and/or the vehicle dynamics control system are adapted accordingly, in particular activated and/or sensitized.

If it is found in step 18, however, that the count status is less than a first predefined count status, step 20 checks whether the counter is lower than a second, lower, predefined count status. If this is not the case, no assessment is made as to whether or not the vehicle is in trailering mode. The status identified in a previous polling cycle is maintained. If, however, the count status is less than the second predefined count status, which is less than the first predefined count status, an identification is then made in step 21 that trailering mode is not present. A corresponding adaptation of the trailer roll logic function and/or of the vehicle dynamics control system is made. In particular, a shutoff or desensitization of the trailer roll logic function is performed. After steps 19, 20, or 21, another cycle is run through.

1 to 24. (canceled)

25. A method for identifying a trailering mode in connection with a towing vehicle, comprising:
identifying the trailering mode by a comparison of an actual signal characterizing a vehicle state with a corresponding target signal.

26. The method according to claim 25, wherein the method is performed by a vehicle dynamics control system having a trailer roll logic function for stabilizing a combination of the towing vehicle and a trailer.

27. The method according to claim 25, wherein the actual signal includes an actual longitudinal vehicle acceleration signal and the target signal includes a target longitudinal vehicle acceleration signal.

28. The method according to claim 25, wherein the target signal is ascertained in accordance with a reference model having at least one input variable, including at least one of (a) a gas pedal travel, (b) a gas pedal acceleration, (c) an engine speed, (d) a current transmission ratio, and (e) a brake inlet pressure.

29. The method according to claim 25, wherein for identification of the trailering mode, a comparison value is ascertained which at least one of (a) corresponds to and (b) is based on a difference between a target longitudinal vehicle acceleration and an actual longitudinal vehicle acceleration.

30. The method according to claim 29, wherein for forming the difference, an actual longitudinal vehicle acceleration measured by an acceleration sensor is subtracted from the target longitudinal vehicle acceleration.

31. The method according to claim 29, wherein for forming the difference, an actual longitudinal vehicle acceleration calculated in consideration of at least one of (a) at least one vehicle wheel rotation speed, (b) at least one vehicle wheel speed, and (c) at least one vehicle wheel acceleration subtracted from the target longitudinal vehicle acceleration.

32. The method according to claim 31, wherein an acceleration component caused by a road slope is purged from the comparison value.

33. The method according to claim 32, wherein purging of the comparison value is accomplished by subtracting the measured actual longitudinal vehicle acceleration and adding the calculated actual longitudinal vehicle acceleration.

34. The method according to claim 29, wherein a classification as trailering mode is made when the comparison value exceeds a first threshold value.

35. The method according to claim 34, wherein upon exceedance of the first threshold value, a count status of a counter is at least one of (a) modified and (b) increased.

36. The method according to claim 34, wherein a classification as non-trailering mode is made when the comparison value falls below a second threshold value.

37. The method according to claim 36, wherein when the value falls below the second threshold, a count status of a counter is at least one of (a) modified and (b) lowered.

38. The method according to claim 36, wherein at least one of (a) the first and the second threshold value are of different magnitudes and (b) the first threshold value is greater than the second threshold value.

39. The method according to claim 35, wherein a trailering mode is identified when a first predefined count status of the counter is reached.

40. The method according to claim 39, wherein a non-trailering mode is identified at least one of (a) when a second predefined count status is reached and (b) when a second predefined count status different from the first count status is reached.

41. The method according to claim 37, wherein at least one of (a) an upper and (b) a lower count status is limited.

42. The method according to claim 27, wherein evaluation of the actual longitudinal vehicle acceleration signal and of the target longitudinal vehicle acceleration signal for trailer identification is activated only upon exceedance of a minimum speed.

43. The method according to claim 27, wherein evaluation of the actual longitudinal vehicle acceleration signal and of the target longitudinal vehicle acceleration signal for trailer identification is activated only upon exceedance of a minimum speed of one of (a) 60 km/h, (b) 70 km/h, and (c) 80 km/h.

44. The method according to claim 27, wherein evaluation of the actual longitudinal vehicle acceleration signal and of the target longitudinal vehicle acceleration signal for trailer identification is activated only upon exceedance of a minimum longitudinal vehicle acceleration.

45. The method according to claim 25, wherein evaluation of the actual signal and of the target signal for trailer identification is activated only upon exceedance of a minimum time span after a braking operation.

46. The method according to claim 25, wherein upon identification of a non-trailering mode, a trailer roll logic function of a vehicle dynamics control system is at least one of (a) switched off, (b) desensitized, (c) temporarily switched off, and (d) temporarily desensitized.

47. The method according to claim 25, wherein when the trailering mode has been identified, at least one of (a) a behavior of a vehicle dynamics control system is modified, (b) an activation of vehicle stabilization interventions is accomplished, and (c) an activation of vehicle stabilization interventions for decreasing instabilities occurring in the trailering mode is accomplished.

48. The method according to claim 25, wherein when non-trailering mode has been identified, at least one of (a) a behavior of a vehicle dynamics control system is modified, (b) one of (i) a deactivation and (ii) an attenuation of vehicle stabilization interventions is accomplished, and (c) one of (i) a deactivation and (ii) an attenuation of vehicle stabilization interventions for decreasing instabilities occurring in trailering mode.

49. The method according to claim 42, wherein at least one of (a) upon deactivation of the evaluation of the actual and target signals for trailer identification and (b) when a speed falls below a minimum value, at least one of (a) the variables used, (b) a count status, and (c) at least one of (i) set and (ii) unset markers are reset.

51. A system, comprising:
a control device adapted to perform a method for identifying a trailering mode in connection with a towing vehicle, the method including identifying the trailering mode by a comparison of an actual signal characterizing a vehicle state with a corresponding target signal.
